(19) United States
(12) Patent Application Publication
(10) Pub. No.: US 2016/0224997 A1
(43) Pub. Date: Aug. 4, 2016

(54) TOTAL SPEND ITEM LEVEL AFFINITY IDENTIFICATION SYSTEM

(71) Applicant: BANK OF AMERICA CORPORATION, Charlotte, NC (US)

(72) Inventors: Jason P. Blackhurst, Charlotte, NC (US); Frederick A. Shahda, Charlotte, NC (US); Alfred Hamilton, Charlotte, NC (US); Robert L. Abbott, Charlotte, NC (US)

(21) Appl. No.: 14/610,901

(22) Filed: Jan. 30, 2015

(51) Int. Cl. G06Q 30/02

(52) U.S. Cl. CPC G06Q 30/0202

(57) ABSTRACT

Embodiments of the invention are directed to a system, method, or computer program product for a distributive network system with specialized data feeds associated with the distributive network for identifying total spend item level affinity for a customer and utilizing the data to provide target advertisement, providing stocking and supplying options for a merchant, and alternatively, for tracking merchant brand association impact. In this way, embodiments of the present invention identify and utilize total spend data for a customer, which includes the products and services a customer purchases within a time period. The invention identifies the customer transactions and subsequently can identify item level data and merchant level data for the transactions within the time period. From this data the system analyzes the total spend to identify loyalty based on merchant, product, or product category. This loyalty information is compiled across multiple customers and compiled for merchant feedback.

### BACKGROUND

Advancements in internet technology, social media, and the like allow for a multitude of options for merchants to advertise products and services. Furthermore, merchants can reach a broader customer base than ever before. However, advertisements typically are directed to customers and are associated with products and services provided by the merchant. While these advancements allow for a broader customer base to potentially be reached and targeted, it remains difficult for a merchant to identify products or brands to stock or advertise an association with for effectiveness.

### BRIEF SUMMARY

Embodiments of the present invention address the above needs and/or achieve other advantages by providing apparatuses (e.g., a system, computer program product and/or other devices) and methods for identifying total spend item level affinity for a customer and utilizing the total spend data for advertisement and promotion targeting. Alternatively, the total spend item level affinity data may be used to track merchant brand association to determine if exclusive brands carried by a merchant positively or negatively impact a customer's shopping experience. Furthermore, the system may also identify alternative brands and/or products that may be carried or stocked by the merchant to positively impact customer shopping experiences.

In this way, embodiments of the present invention include systems, methods, and computer-program products for identifying and utilizing total spend data for a customer. Total spend is all the products and services a customer purchases within a given time period. The invention identifies the customer transactions and subsequently can identify item level data and merchant level data for the transactions within the time period. From this data the system analyzes customer habits to identify customer loyalty to a merchant or to a brand of product. This loyalty information is compiled across multiple customers and compiled for merchant feedback.

In some embodiments, the system identifies user total spend. Total spend includes all of the products and/or services purchased by a customer within a pre-determined total spend time period. The customer total spend may first identify the time period and then identify customer transactions that occurred during that time period. The customer transactions are identified by the financial product the customer used for the transaction. As such, if the financial institution associated with the total spend item level affinity identification system was also the issuing bank of the credit card the customer used for transactions during the time period, the system can retrieve the transaction data associated with those transactions. In some embodiments, the customer may provide the system receipts or other transaction data associated with the transactions during the total spend time period. Finally, the system may retrieve transaction data from merchants, other financial institutions, or the like.

Based on the retrieved data, the system may identify item level data for the products of the transaction. Item level data includes specific details about the items of the transaction and more specifically, the brand, name, item number, price, manufacturer, or the like associated with the product. Furthermore, the system may identify item level data by retrieving the data or extracting the data off of a receipt, confirmation, or the like associated with the transaction. Finally, the system may receive the item level data from merchant communications. In some embodiments, the system may then compile the item and merchant level transaction data for the customer across the time total spend time period.

In some embodiments, the system may identify loyalty of customers to merchants, brands, or product category. In this way, in some embodiments, the system identifies merchant patterns based on the item level data. In some embodiments, the system identifies product patterns based on the item level data. In yet other embodiments, the system identifies category patterns based on the item level data. The patterns identify which products the customer is purchasing, during a time frame, at each merchant. In this way, the system using a distributive network through specific network data feeds of the unique distributive network allows for patterning and mapping of item level product purchase data at merchants during a time period. For example, the system may identify that a customer purchases meat and poultry at Merchant X, but all other grocery goods at Merchant Y. In this way, there may be a brand or category loyalty to the meat and poultry goods at Merchant X, while an overall merchant loyalty or affinity for Merchant Y.

The system, through use of data feeds and a system distributive network, is triggered, via a triggering event, such as the time frame expiring for the total spend, to compile and generalize the affinity or loyalty data across the financial institution. The compiled data may then be used to be presented to a merchant in the form of total spend feedback data. This data may be transformed into feedback data for one or more of merchant stocking feedback, brand or category association influence feedback, and/or target advertisement feedback. Feedback data for merchant stocking may include identifying product brands or product categories that the merchant stocks but that a customer is going elsewhere for and/or identifying product brands or product categories that the merchants do not stock that customers of that merchant are purchasing at other merchants. Feedback data for brand or category association influence includes identifying exclusive brands carried by the merchant and the impact of those brands on customer loyalty for that merchant.

Embodiments of the invention relate to systems, methods, and computer program products for item level affinity tracking, the invention comprising: identifying customer transactions occurring within a time range that utilizes a financial institution product; trigging through the network data feeds a collection of customer transaction data based on the identification of customer transactions, occurring with the time range; retrieving, utilizing the distributive network and the specific network data feeds, item level data for products of the transaction, wherein item level data includes specific information identifying a product including a model number, name, and manufacturer of the product of the transaction; compiling the item level data across a financial institution; identifying an affinity of the customer for merchants based on the customer transactions and item level data within the time range; identifying an affinity of the customer for product brands based on the customer transactions and item level data within the time range; generalizing the identified affinity of the customer for merchants and brands for one or more customers; and providing through the network data feeds feedback data to merchants for one or more of merchant product stocking feedback, brand or category association influence feedback, and/or target advertisement feedback.

In some embodiments, identifying an affinity of the customer for merchants based on the customer transactions and item level data within the time range further comprises identifying patterns in the customer transactions illustrating a loyalty to one or more merchants, wherein the system uses the distributive network through specific network data feeds of the distributive network to pattern and map the merchant where the customer purchased each item associated with the item level data for the customer transactions during the time period.

In some embodiments, identifying an affinity of the customer for product brands based on the customer transactions and item level data within the time range further comprises identifying patterns in the customer transactions illustrating a loyalty to one or more brands of products, irrespective of the merchant of the customer transactions, wherein the system uses the distributive network through specific network data feeds of the distributive network to pattern and map the brands of products purchased during the customer transactions using the item level data for the customer transactions during the time period.

In some embodiments, the invention further comprises providing exclusive brand impact feedback to the merchant, wherein providing exclusive brand impact feedback to the merchant comprises: identifying exclusive brands of the merchant, wherein the exclusive brands of the merchant are product brands exclusively carried by the merchant; identifying one or more customers that transact with that merchant based exclusively on the brand based on the compile item level data; identifying the one or more customers that are merchant loyal and purchase the exclusive brand product because it is available at the merchant based on the compile item level data; identifying the one or more customers that do not transact at the merchant because of the exclusive brand product based on the compile item level data; patterning the compile item level data based on the identification of one or more customers that transact with that merchant based exclusively on the brand, the one or more customers that are merchant loyal and purchase the exclusive brand product because it is available at the merchant, and the one or more customers that do not transact at the merchant because of the exclusive brand product based on the compile item level data; and providing the merchant with feedback based on the patterning.

In some embodiments, generalizing the item level data across the financial institution further includes removing customer information from the item level data and correlating each of the products of each of the transactions for the item level data into a category of product, brand of product, and/or by merchant associated with the transaction.

In some embodiments, providing merchant product stocking feedback further comprises: determining products or categories of products that one or more customers purchase exclusively at the merchants; determining one or more customers that transact at the merchant but do not purchase the products or categories of products at that merchant but instead purchase those products or categories of products at a second merchant; and presenting merchant with merchant product stocking feedback comprising an interactive interface for review of the feedback to aid the merchant in bringing in or continuing to maintain customers and/or providing the merchant with information related to which products should be provided and maintained at the merchant.

In some embodiments, providing target advertisement feedback further comprises: determining products or categories of products that one or more customers purchase exclusively at the merchants; determining customers that do not transact at the merchant and determine the products or category of products that the customers purchase at a second merchant; and presenting merchant with target advertisement feedback for the customers that do not transact at the merchant, wherein the target advertisements are for the products or category of products that the customers purchase at a second merchant.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a high level process flow illustrating the total spend item level affinity identification process, in accordance with one embodiment of the present invention;

FIG. 2 provides a total spend item level affinity system environment, in accordance with one embodiment of the present invention;

FIG. 3 provides a process map illustrating identifying products and merchants during a total spend time period, in accordance with one embodiment of the present invention;

FIG. 4 provides a process map illustrating item level identification and affinity associated therewith, in accordance with one embodiment of the present invention;

FIG. 5 provides a process map illustrating identifying and presenting total spend data to a merchant for branding and stocking effectiveness, in accordance with one embodiment of the present invention;

FIG. 6 provides a process flow illustrating identifying and presenting total spend data to merchants for advertisement effectiveness, in accordance with one embodiment of the present invention; and

FIG. 7 provides a process flow illustrating identifying item level transaction data, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that may are associated with total spend item level affinity identification.

Some portions of this disclosure are written in terms of a financial institution's unique position with respect to customer transactions. As such, a financial institution may be able to utilize its unique position to monitor and identify transactions for products or with merchants that utilize financial institution accounts to complete the transactions.

The embodiments described herein may refer to the initiation and completion of a transaction. Unless specifically limited by the context, a “transaction”, “transaction event” or “point of transaction event” refers to any customer completing or initiating a purchase for a product, service, or the like. The embodiments described herein may refer to an “advertisement.” An advertisement, as used herein may include one or more of a deal, offer, coupon, promotion, incentive, commercial, advertisement, or the like. The advertisement may be for a product, service, merchant, merchant, brand, or the like. Furthermore, the term “product” as used herein may refer to any product, service, good, or the like that may be purchased through a transaction.

Furthermore, the term “electronic receipt” or “e-receipt” as used herein may include any electronic communication between a merchant and a customer, where the communication is associated with a transaction. In this way, e-receipts may include information about the transaction, such as location of purchase, the transaction total, order confirmations, shipping confirmations, item description, SKU data, merchant name, merchant web address, order number, order date, product description, product name, product quantity, product price, product image, hyperlink to the product image on merchant website, sales tax, shipping cost, order total, billing address, shipping company, shipping address, estimated shipping date, estimated delivery date, tracking number, and the like.

The embodiments described herein may refer to the use of a transaction, transaction event or point of transaction event to trigger the steps, functions, routines, or the like described herein. In various embodiments, occurrence of a transaction triggers the sending of information such as offers and the like. Unless specifically limited by the context, a “transaction”, “transaction event” or “point of transaction event” refers to any communication between the customer and the merchant, e.g. financial institution, or other entity monitoring the customer's activities. In some embodiments, for example, a transaction may refer to a purchase of goods or services, a return of goods or services, a payment transaction, a credit transaction, or other interaction involving a customer's bank account. As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a customer's computer or mobile device, a customer accessing their e-wallet or any other interaction involving the customer and/or the customer's device that is detectable by the financial institution. As further examples, a transaction may occur when an entity associated with the customer is alerted via the transaction of the customer's location. A transaction may occur when a customer accesses a building, uses a rewards card, and/or performs an account balance query. A transaction may occur as a customer's mobile device establishes a wireless connection, such as a Wi-Fi connection, with a point-of-sale (or point-of-transaction) terminal. In some embodiments, a transaction may include one or more of the following: purchasing, renting, selling, and/or leasing goods and/or services (e.g., groceries, stamps, tickets, DVDs, vending machine items, and the like); withdrawing cash; making payments to creditors (e.g., paying monthly bills; paying federal, state, and/or local taxes and/or bills; or the like); sending remittances; transferring balances from one account to another account; loading money onto stored value cards (SVCs) and/or prepaid cards; donating to charities; and/or the like.

In some embodiments, the transaction may refer to an event and/or action or group of actions facilitated or performed by a customer's device, such as a customer's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the customer's perspective, the merchant's perspective or both. In some embodiments, the point-of-transaction device refers only to a customer's device, in other embodiments it refers only to a merchant device, and in yet other embodiments, it refers to both a customer device and a merchant device interacting to perform a transaction. For example, in one embodiment, the point-of-transaction device refers to the customer's mobile device configured to communicate with a merchant's point of sale terminal, whereas in other embodiments, the point-of-transaction device refers to the merchant's point of sale terminal configured to communicate with a customer's mobile device, and in yet other embodiments, the point-of-transaction device refers to both the customer's mobile device and the merchant's point of sale terminal configured to communicate with each other to carry out a transaction.

In some embodiments, a point-of-transaction device is or includes an interactive computer terminal that is configured to initiate, perform, complete, and/or facilitate one or more transactions. A point-of-transaction device could be or include any device that a customer may use to perform a transaction with an entity, such as, but not limited to, an ATM, a loyalty device such as a rewards card, loyalty card or other loyalty device, a magnetic-based payment device (e.g., a credit card, debit card, or the like), a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, MP3 device, personal GPS device, or the like), a merchant terminal, a self-service machine (e.g., vending machine, self-checkout machine, or the like), a public and/or business kiosk (e.g., an Internet kiosk, ticketing kiosk, bill pay kiosk, or the like), a gaming device, and/or various combinations of the foregoing.

In some embodiments, a point-of-transaction device is operated in a public place (e.g., on a street corner, at the doorstep of a private residence, in an open market, at a public rest stop, or the like). In other embodiments, the point-of-transaction device is additionally or alternatively operated in a place of business (e.g., in a retail store, post office, banking center, grocery store, factory floor, or the like). In accordance with some embodiments, the point-of-transaction device is not owned by the customer of the point-of-transaction device. Rather, in some embodiments, the point-of-transaction device is owned by a mobile business operator or a point-of-transaction operator (e.g., merchant, vendor, salesperson, or the like). In yet other embodiments, the point-of-transaction device is owned by the financial institution offering the point-of-transaction device providing functionality in accordance with embodiments of the invention described herein.

Embodiments of the invention are directed to a system, method, or computer program product for a distributive network system with specialized data feeds associated with the distributive network and specific triggering events associated with the data feeds for identifying total spend item level affinity for a customer and utilizing the data to provide target advertisement, providing stocking and supplying options for a merchant, and alternatively, for tracking merchant brand association impact. In this way, embodiments of the present invention identify and utilize total spend data for a customer, which includes the products and services a customer purchases within a time period. The invention identifies the customer transactions and subsequently can identify item level data and merchant level data for the transactions within the time period. From this data the system analyzes the total spend to identify loyalty based on merchant, product, or product category. This loyalty information is compiled across multiple customers and compiled for merchant feedback.

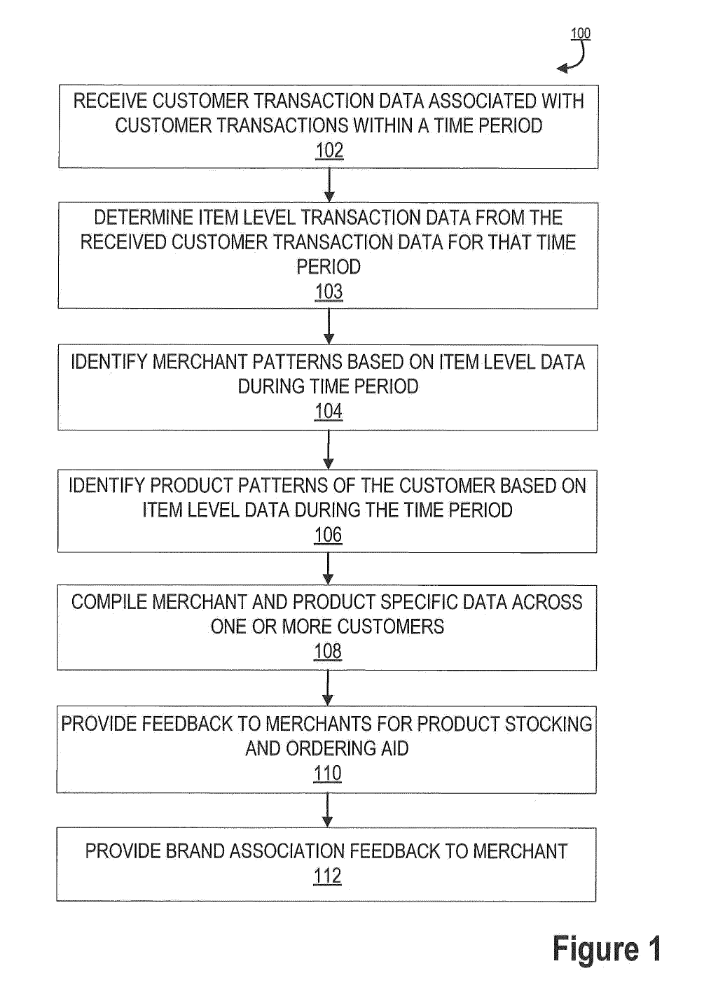

FIG. 1 provides a high level process flow illustrating the total spend item level affinity identification process 100, in accordance with one embodiment of the present invention. As illustrated in block 102, the process is initiated by receiving customer transaction data associated with customer transactions within a time period. The transaction data may be identified based on financial institution product, such as a credit card, or the like being used for the transaction and/or the system may receive the transaction data from the customer, another financial provider, and/or the merchant of the transaction. Transaction data includes data associated with a transaction between a customer and a merchant, including, but not limited to data on a receipt, such as a product price, total price, product identifier, SKU numbers, and/or the like.

Next, as illustrated in block 103, the process continues by determining item level transaction data from the received customer transaction data for that time period. In this way, the system may receive and extract item level data from a SKU associated with the products of the purchase, receive information from a merchant, and/or receive information from a customer about the brand, type, name, price, item number, and the like associated with products of the transaction. In this way, the system may identify specific items of transactions a customer made during a given time frame. As such, identifying specific item information beyond the information a processing financial institution may have knowledge of while processing a transaction for payment.

As illustrated in block 104, the item level data is used to identify merchant patterns during a time period. In this way, the system identifies specific products or types of products that a customer buys at a given merchant. Subsequently, the system uses this data to identify relative patterns associated with the customer's spending for the time period. Next, as illustrated in block 106, the process continues to identify product patterns of the customer based on the item level data during the specific time period. In this way, the system may identify specific brands, sizes, quantities, or the like of items purchased during a time period to identify patterns in the customer's purchases during that time period.

As illustrated in block 108, the process continues by compiling merchant and product specific data and the patterns identified therewith across one or more customers. Next, the process provides feedback to merchants for product stocking and ordering aid for products to be supplied by the merchant. The feedback is based on the compiled merchant and product specific data and patterns identified associated with the data, as illustrated in block 110. Finally, as illustrated in block 112, the process also provides feedback to a merchant based on brands association with that merchant. In this way, the system identifies and provides the merchant with feedback to determine if exclusive brands carried by the merchant either positively or negatively impact a customer shopping experience at that merchant.

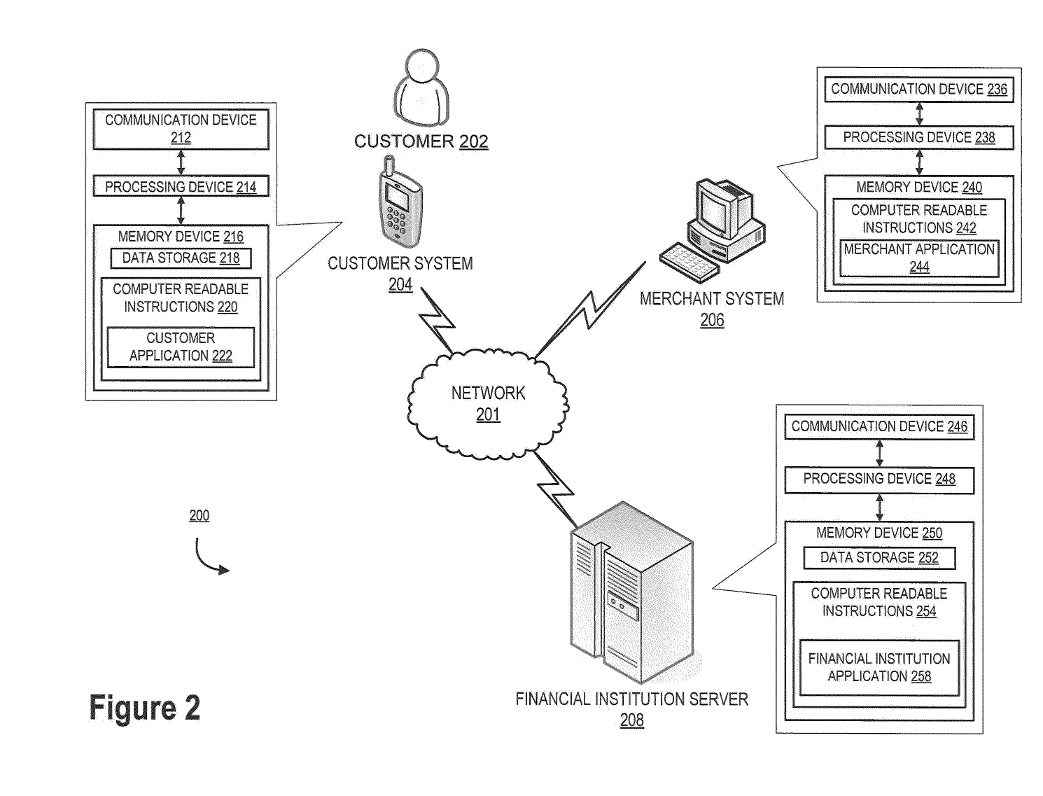

FIG. 2 illustrates a total spend item level affinity system environment 200, in accordance with one embodiment of the present invention. FIG. 2 provides the system environment 200 for which the distributive network system with specialized data feeds associated with the distributive network and specific triggering events associated with the data feeds identify total spend item level affinity for a customer and utilizing the data to provide target advertisement, providing stocking and supplying options for a merchant, and alternatively, for tracking merchant brand association impact.

As illustrated in FIG. 2, the financial institution server 208 is operatively coupled, via a network 201 to the customer system 204, and to the merchant system 206. In this way, the financial institution server 208 can send information to and receive information from the customer system 204 and the merchant system 206 to provide customer transaction prompting advertisement presentment and impressions data. FIG. 2 illustrates only one example of an embodiment of a total spend item level affinity system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the customer 202 is an individual consumer shopping at one or more online or brink-and-mortar merchant locations within a given time period. The customer 202 may make one or more transactions to purchase a product. In some embodiments, the purchase may be made by the customer 202 using a customer system 204.

FIG. 2 also illustrates a customer system 204. The customer system 204 generally comprises a communication device 212, a processing device 214, and a memory device 216. The customer system 204 is a computing system that allows a customer 202 to interact with the financial institution to set up payment or transaction accounts to complete transactions for products and/or services. The processing device 214 is operatively coupled to the communication device 212 and the memory device 216. The processing device 214 uses the communication device 212 to communicate with the network 201 and other devices on the network 201, such as, but not limited to the merchant system 206 and the financial institution server 208. As such, the communication device 212 generally comprises a modem, server, or other device for communicating with other devices on the network 201.

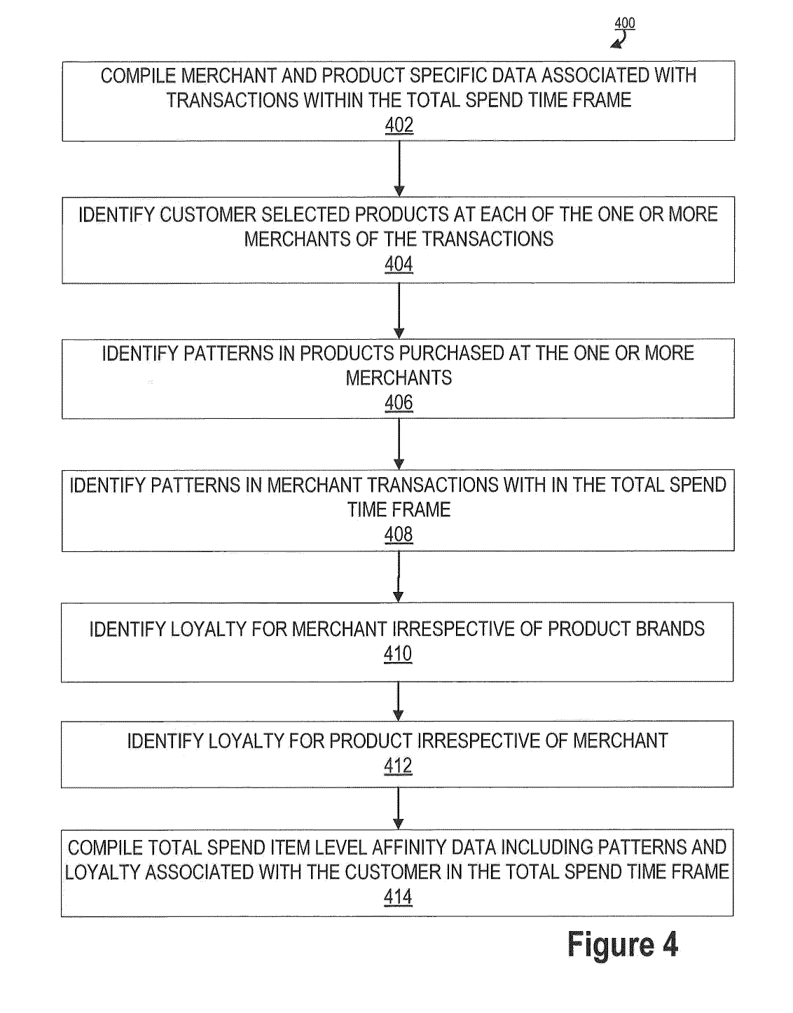

The customer system 204 comprises computer-readable instructions 220 and data storage 218 stored in the memory device 216, which in one embodiment includes the computer-readable instructions 220 of a customer application 222. In this way, a customer 202 may open a financial institution account, remotely communicate with the financial institution, authorize and complete a transaction, or complete a transaction using the customer's customer system 204. The customer system 204 may be, for example, a desktop personal computer, a mobile system, such as a cellular phone, smart phone, personal data assistant (PDA), laptop, or the like. Although only a single customer system 204 is depicted in FIG. 4, system environment 200 may contain numerous customer systems 204.

As further illustrated in FIG. 2, the financial institution server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the merchant system 206 and the customer system 204. As such, the communication device 246 generally comprises a modem, server, or other device for communicating with other devices on the network 201.

As further illustrated in FIG. 2, the financial institution server 208 comprises computer-readable instructions 254 stored in the memory device 250, which in one embodiment includes the computer-readable instructions 254 of a financial institution application 258. In some embodiments, the memory device 250 includes data storage 252 for storing data related to the customer transaction prompting advertisement presentment system environment, but not limited to data created and/or used by the financial institution application 258.

In the embodiment illustrated in FIG. 2 and described throughout much of this specification, the financial institution application 258 may identify a customer 202 total spend, receive customer transaction data, determine item level transaction data from the received customer transaction data, determine affinity or loyalty data across the financial institution, generalize the item level transaction data across the financial institution, and provide feedback data for one or more of merchant stocking feedback, brand or category association influence feedback, and/or target advertisement feedback.

In some embodiments, the financial institution application 258 may identify a customer 202 total spend. Total spend includes all of the products and/or services purchased by a customer within a pre-determined total spend time period. In this way, the financial institution application 258 may identify a total spend time period, such as a past day/week/weeks/months/years. Once a total spend time period is determined, the financial institution application 258 may continue by identifying customer transactions during that time period. The customer transactions may be identified based on a customer 202 using one or more financial institution products, such as credit cards, debit cards, checks, or the like, to complete the transaction. In other embodiments, the merchants, customer 202, or other financial institutions may provide the financial institution application 258 or the financial institution application 258 may retrieve the information identifying customer transactions within the time period. The customer transaction data may identify one or more financial transactions of the customer 202 for products, merchants, or services associated with a merchant. The customer transaction data may be identified based on electronic communications between the merchant and customer and/or stock keeping unit (SKU) identification. In some embodiments, the financial institution application 258 may be provided with the customer transaction data from a financial institution. In some embodiments, the financial institution application 258 may determine customer transaction data by receiving or retrieving information from the merchant, social networks, and/or the customer.

Customer transaction data may be utilized to determine item level data that includes item level information about each product or service of a transaction. As such, customer transaction data may be received in the form of SKU level data and/or data from electronic communications between the customer and merchant. SKU level data may be received via the network 201. SKU level data may include specific information about a product purchased by a customer during a customer transaction. This may include codes or the like that identify the specific products of the transaction. The electronic communications data may include one or more of an electronic receipt, invoice, payment, order, report, or other communication identifying a transaction between the customer and merchant.

In some embodiments, the financial institution application 258 may determine item level transaction data from the received customer transaction data. As such, the financial institution application 258 may determine item level data from the received customer transaction data, such as SKU level data, received transaction data from merchants or customers, and/or the like. Item level data identifies the specific item associated with the received SKU level data or the received electronic communications data. In this way, the specific item, price, model number, merchant, manufacturer, brand, or the like may be identified.

In some embodiments, the financial institution application 258 may determine total spend data for customers 202. Total spend data may include affinity or loyalty data across the financial institution. In this way, in some embodiments, the financial institution application 258 may identify merchant patterns based on the item level data. Merchant patterns indication a systematic or rhythmic pattern of customer 202 shopping at a specific merchant during the total spend time period. As such, based on item level data the financial institution application 258 identifies patterns in merchant shopping for the customer 202. In some embodiments, the financial institution application 258 identifies product patterns based on the item level data. In this way, the financial institution application 258 may identify patterns in categories or brands of products purchase. As such, the financial institution application 258 identifies that the customer 202 always purchases Brand X hot dogs. Furthermore, the financial institution application 258 may identify categories of products that the customer purchases. For example, that the customer purchases all meat products at Merchant Y.

In this way, the financial institution application 258 utilizes unique patterning applications for the distributive network utilizing data feeds and process flows to systematically identify patterns in customer transactions over the course of the total spend time frame. Patterns may also include one or more transactions for specific products or product categories and the merchants associated with each of those products arranged in logic based on the product, category, and merchant associated with each of the transactions within the time period. These patterns attribute to customer 202 loyalty or affinity for products, brands, categories, or merchants. Furthermore, the financial institution application 258 identifies levels of loyalty based on which products, categories of products, or brands of products are purchased at which merchant. For example, if a customer 202 purchases all groceries except meats at Merchant Y, but purchases meats at Merchant X, the financial institution application 258 identifies this pattern and determines that the customer 202 has a loyalty to Merchant Y, but a stronger affinity to the category of meats or brand of meats provided at Merchant X. This could provide valuable data to Merchant Y and Merchant X about their branding, products, and specifically their meat category of products as it relates to that customer 202.

In some embodiments, the financial institution application 258 recognizes patterns that identify which products the customer 202 is purchasing, during a time frame, at each merchant. In this way, the system using a distributive network through specific network data feeds of the unique distributive network allows for patterning and mapping of item level product purchase data at merchants during a time period. For example, the system may identify that a customer purchases meat and poultry at Merchant X, but all other grocery goods at Merchant Y. In this way, there may be a brand or category loyalty to the meat and poultry goods at Merchant X, while an overall merchant loyalty or affinity for Merchant Y.

In some embodiments, the financial institution application 258 may generalize the item level transaction data across the financial institution. In this way, the financial institution application 258 may compile the item level transaction data across the financial institution. As such, item level transaction data may be compiled together and grouped based on pattern, loyalty, merchant, customer 202, product, brand, category, or the like. Subsequently, the data compiled is generalized within the financial institution by the financial institution application 258. As such, the generalized information includes information about a number of customers that purchased a product, a category of products, or from a merchant within the total spend period. The generalized information does not include information about the customer 202 making a purchase, but instead general numbers associated with the number of customers that purchased a product, a category of products, or from a merchant within a given time period.

In some embodiments, the financial institution application 258 may provide feedback data for one or more of merchant stocking feedback, brand or category association influence feedback, and/or target advertisement feedback to a merchant via a network 201 to the merchant system 206. The feedback may be in the form of generalized item level transaction data in the form of graphs, charts, or the like that depict loyalty, affinity, product, product category, or the like. This data may be presented from the financial institution application 258 via the network 201 to the merchant system 206. The feedback may be presented via an interface or the like in an interactive format such that the merchant may further search or identify the data required for future feedback the merchant desires.

In some embodiments, the financial institution application 258 may provide merchant stocking feedback. In this way, the financial institution application 258 may determine products or categories of products that customers 202 relocate to other merchants to purchase. In this way, the financial institution application 258 may provide the requesting merchant feedback as to the products that the merchant carries that aid the merchant in bringing in or continuing to maintain customers and/or providing the merchant with information related to which products should be provided and maintained at the merchant.

In some embodiments, the financial institution application 258 may provide brand or category association influence feedback. In this way, the financial institution application 258 may analysis item level data and provide the merchant with an indication as to the effects that brands the merchant currently carries, both positive and negative, based on the item level data and loyalty data identified.

In some embodiments, the financial institution application 258 may provide target advertisement feedback. In this way, the financial institution application 258 may provide, based on the item level data, one or more merchants with feedback based on tie patterns and/or loyalty data that provide the merchant with targeted advertisement feedback.

As illustrated in FIG. 2, the merchant system 206 is connected to the financial institution server 208 and is associated with a merchant selling products or services. In this way, while only one merchant system 206 is illustrated in FIG. 2, it is understood that multiple merchant systems may make up the system environment 200. The merchant system 206 generally comprises a communication device 236, a processing device 238, and a memory device 240. The merchant system 206 comprises computer-readable instructions 242 stored in the memory device 240, which in one embodiment includes the computer-readable instructions 242 of an merchant application 244.

In the embodiment illustrated in FIG. 2, the merchant application 244 provides products and services to a customer 202 and is part of one or more customer transactions, provides advertisements to customers 202, and presents requests for item level spend data, and receives feedback for one or more of merchant stocking feedback, brand or category association influence feedback, and/or target advertisement feedback.

In some embodiments, the merchant application 244 may be part of a network associated with the merchant that provides products and services to a customer 202 via online or mobile means. Furthermore, the merchant application 244 may be associate with a brink-and-mortar merchant location. As such, the merchant application 244 may be a part of one or more customer transactions when the customer 202 transacts with the merchant.

In some embodiments, the merchant application 244 may provide the advertisements to the customers 202. The merchant application 244 may present advertisements via online means or offline means based on the targeted audience the merchant wishes to target. In some embodiments, the merchant application 244 may operate in conjunction with the financial institution application 258 to determine that a customer 202 viewed an advertisement and the identification of the customer 202 who viewed the advertisement.

In some embodiments, the merchant application 244 may request for item level spend data from the financial institution application 258. In this way the merchant application 244 may communicate with the financial institution application 258 via the network 201 to request total spend feedback data. Feedback data may be associated with product stocking recommendations, brand influence data, and advertisement recommendations. The feedback data comprise generalized customer data about item level purchases categorized by product, product category, and/or merchant. In some embodiments, the request for total spend feedback data may be for a specific geographic region, demographic, product, merchant, or the like. In this way, the merchant may request data to better target customers in future advertisements based on categorized item level transaction data for customer purchases. The request may be for generalized data in the form of graphs, charts, or the like that depict the purchases associated with that request. As such, the merchant application 244 may provide advertisements to the customer 202 based on the received advertisement correlation data.

The merchant application 244 may receive feedback for one or more of merchant stocking feedback, brand or category association influence feedback, and/or target advertisement feedback from the financial institution server 208 via a network 201. The feedback may be in several forms, including providing stocking recommendations, providing branding influence data, and/or providing advertisement recommendations. This data may be generalized item level transaction data based on category, product, merchant, and request of the merchant. This data may be provided in graph, chart, or other form on an interactive interface, such that the merchant may request or search of data within other fields to be provided with the feedback data.

The merchant application 244 may receive feedback communication via the network 201 from the financial institution application 258. In some embodiments, the feedback maybe based on the results of the merchant and product patterns identified by the system. In this way, the financial institution server 208 may generate total spend data related to product, category, and/or merchant loyalty based on patterns of transaction s of customers 202 within a time frame.

It is understood that the servers, systems, and devices described herein illustrate one embodiment of the invention. It is further understood that one or more of the servers, systems, and devices can be combined in other embodiments and still function in the same or similar way as the embodiments described herein.

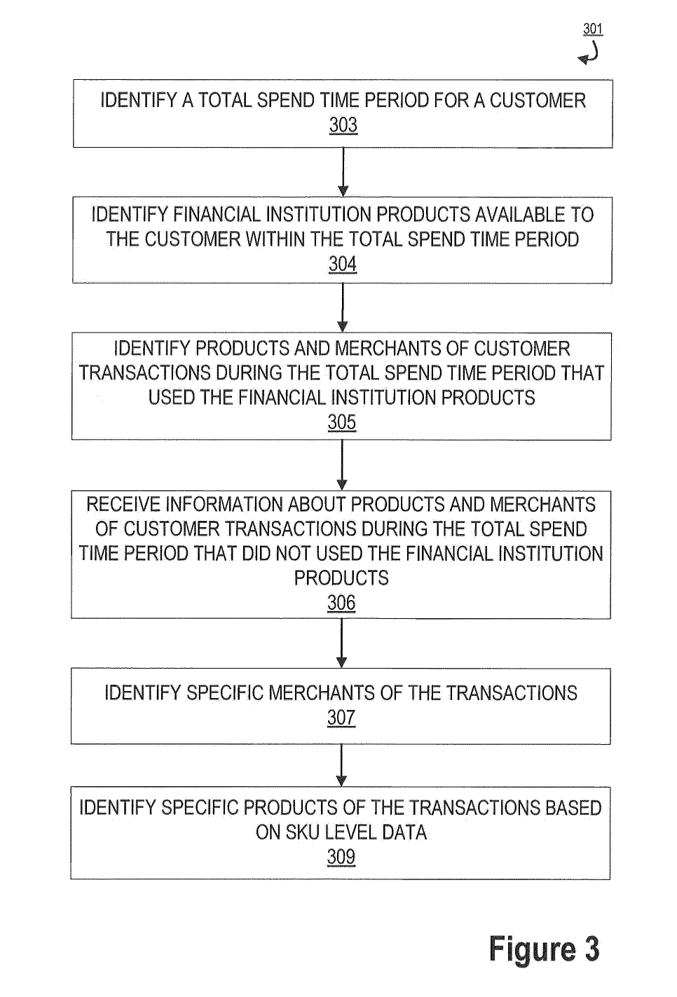

FIG. 3 illustrates a process map for identifying products and merchants during a total spend time period 301, in accordance with one embodiment of the present invention. The process 301 is initiated by identifying a total spend time period for a customer, as illustrated in block 303. This time period may be determined by the system based on a number of transactions for data analysis identified during a time period. The time period may be for days, weeks, months, or years. Furthermore, the time period may be based on customer location. For example, if a customer has recently moved, then the time period may only be for the duration of time at the customer's new location.

Once a total spend time period has been determined, next the system identifies financial institution products available to the customer within that time period, as illustrated in block 304. In this way, the system which is associated with a financial institution may identify the customer, and any financial institution payment products that the customer may have with the financial institution. These payment products may include one or more credit cards, debit card, checking accounts, savings account, or other financial institution provided payment means.

Once these payment products have been identified, the process 301 then identified products and merchants of customer transactions during the total spend time period where the financial institution product was used to complete the transaction, as illustrated in block 305. While specific item level data may not be identified at this step in the process 301, the system is able to determine total transaction cost, some generic data about the products of the transaction, as well as the merchant of the transaction.

Based on identifying the products and merchants of the customer transactions during the total spend time period in block 305, the process 301 continues by receiving or retrieving information about products and merchants of customer transactions during the total spend time period that did not use financial institution products, as illustrated in block 306. In this way, the system may receive information indicating products and merchants of customer transactions. This information may be provided to the system from the merchant, customer, or another financial institution. In this way, the customer could have used any payment device to complete the transaction.

Next, as illustrated in block 307, the system may identify specific merchants of the transactions. Typically, the merchant may be identified based on the generalized data received by the system. The data usually includes a total price, general information about the products purchased, the price of the products, and the name of the merchant associated with the transaction. Finally, as illustrated in block 309 the system may identify specific item level information about the products and merchants of the transaction.

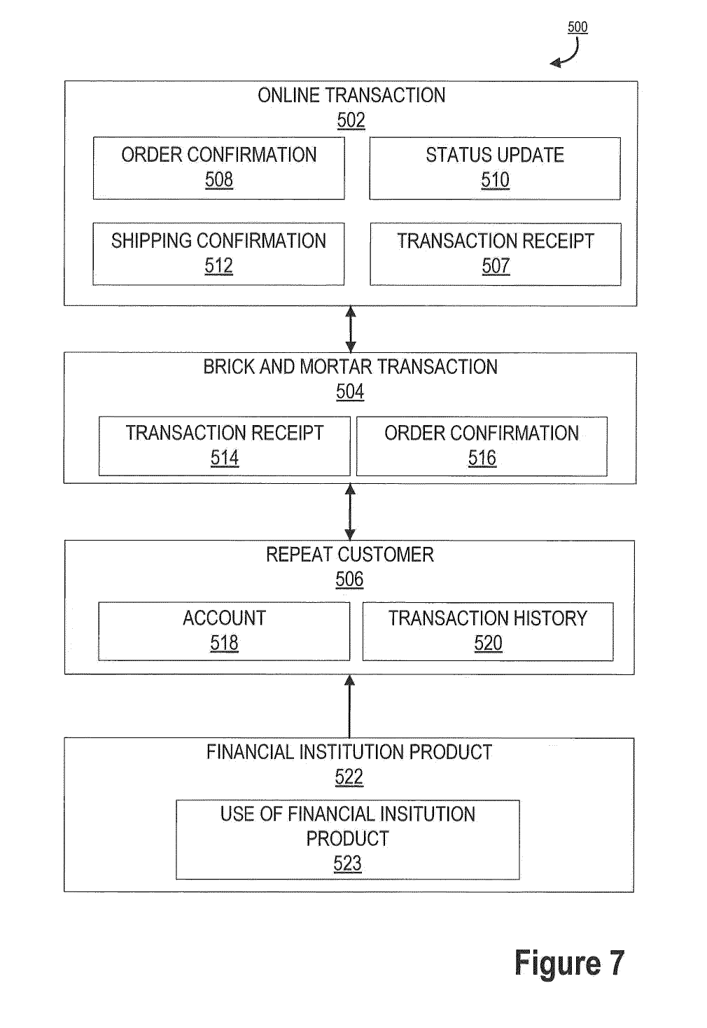

Identifying item level and merchant level transaction data for the total spend time period is illustrated in further detail below with respect to FIG. 7.

FIG. 7 provides a process flow illustrating identifying item level transaction data 500, in accordance with one embodiment of the present invention. Specific item level transaction data, including a price, product number, product name, brand, or the like, may be derived from online transactions 502, brick and mortar transactions 504, repeat customer 506 transactions, or financial institution products 522 used. Furthermore, this information may be provided directly by the customer 202 and/or the merchant.

In some embodiments, online transaction 502 communications may include transaction receipts 507. Other communications for online transactions 502 may include order confirmations 508, status updates 510, shipping updates 512, or the like. The combination of all of these communications may be considered e-receipts. E-receipts may be any electronic communication from a merchant to a customer based on a transaction. An order confirmation 508 may include detailed information regarding the products or services purchased. For example, in the case of a product, the order confirmation may include stock keeping unit “SKU” code level data, as well as other parameters, such as order number, order date, product description, product name, product quantity, product price, product image, hyperlink to the product image on merchant website, sales tax, shipping cost, order total, billing address, shipping company, shipping address, estimated shipping date, estimated delivery date, tracking number, and the like. The order confirmation 508 also includes information about the merchant, such as name, address, phone number, web address, and the like. The shipment confirmation 512 may be an email, text, voice, or other correspondence from a merchant to a customer indicating the shipment of a product from an online transaction. Status updates 510 may include any type of communication from a merchant that may update the shipping, delivery, order, or stocking of a product of a transaction.

In some embodiments, item level data may be identified based on transactions at a brick and mortar location 504. In this way, many merchants now also provide e-receipts and other electronic communications to customers shopping at brick and mortar locations. In some embodiments, these communications may include transaction receipts 514, such as an e-receipt. In other embodiments, these communications may include order confirmations 516. In general, at the point of sale, the customer may have previously configured or may be asked at the time of sale as to whether he/she wishes to receive an e-receipt. By selecting this option, the merchant will send an electronic communication in the form of an e-receipt to the customer's designated email address.

Here again, the e-receipt will typically include a list of services and/or products purchased with SKU level data, and other parameters, as well as information about the merchant, such as name, address, phone number, store number, web address, and the like.

In some embodiments, item level data may be identified from a repeat customer account 506. Various merchants now also provide online customer accounts 518 for repeat customers. These online customer accounts 518 may include purchase history 520 information associated with the customer accessible by the customer via ID and passcode entry. Purchase history provides detailed information about services and products purchased by the customer including information found on order confirmations and shipping confirmations for each purchase. Online customer accounts are not limited to online purchases. Many merchants also provide online customer accounts for customers that purchase services and products at brick and mortar locations and then store these transactions in the customer's online account.

In some embodiments, item level data may be identified from financial institution products 522 used during a transaction 523. In this way, the system may identify one or more transactions that the customer 202 used a financial institution product 522, such as a credit card, debit card, check, or the like. The system may then be able to identify the transaction based on being the authorizing financial institution of the transaction. As such, the system may receive general information about the transaction and the total price of the transaction. Using this information, the system may request item level data for the merchant and/or customer 202 for the specifically identified transaction. Finally, item level transaction data may be provided directly to the system by the customer 202 and/or the merchant of the transaction.

The system may identify item level transaction data associated with a transaction. This item level transaction data includes product purchase level data from a transaction between the merchant and customer. The system may extract the item level transaction data identified. This extraction may be from a customer account, such as an email account or the like. In other embodiments, the extraction may be from a text, voice, or the like message communicated to the customer.

Regarding email extraction, the system may initially receive authorization for access to the customer's email accounts and retrieves email message headers comprising data fields relative to the email message, such as sender, subject, date/time sent, recipient, and the like. In some embodiments, the system accesses the emails directly. In other embodiments, the system may run search queries of the email database based on known merchant names and/or phrases associated with e-receipt information, such as “receipt,” “order confirmation,” “shipping confirmation,” or the like. Once emails are extracted, further filtering may occur to locate relevant emails. Examples of further filtering may be searches based on known online merchants, third parties known to provide e-receipts, text in the email message subject line that corresponds to known order confirmation subject line text or known shipping confirmation subject line text, such as an email message sent with a subject line containing the text “purchase,” “order,” “ordered,” “shipment,” “shipping,” “shipped,” “invoice,” “confirmed,” “confirmation,” “notification,” “receipt,” “e-receipt,” “e-receipt,” “return,” “pre-order,” “pre-ordered,” “tracking,” “on its way,” “received,” “fulfilled,” “package,” and the like.

In some embodiments, the system may convert the identified item level transaction data from the communication into a structured format for the online banking application to utilize the transaction data extracted.

Financial institutions currently use a data structure conforming to Open Financial Exchange “OFX” specifications for the electronic exchange of financial data between financial institutions, businesses and customers via the Internet. E-receipts, such as electronic order confirmations, shipment confirmation, receipts, and the like typically do not comply to a uniform structure and are generally considered to include data in an “unstructured” format. For example, while one merchant may provide data in an electronic communication to a customer in one format, another merchant may use a completely different format. One merchant may include merchant data at the top of a receipt and another merchant may include such data at the bottom of a receipt. One merchant may list the purchase price for an item on the same line as the description of the item and list the SKU number on the next line, while another merchant may list the data in a completely opposite order. As such, prior to integration of electronic communications relating to customer purchases into online banking, the data from such electronic communications must be parsed into a structured form.

FIG. 4 provides a process map illustrating item level identification and affinity associated therewith 400, in accordance with one embodiment of the present invention. As illustrated in block 402, the process 400 is initiated by compiling item level data, such as merchant and product specific data associated with the transactions within the total spend time frame for that customer. Once all the item level data is compiled such that for each transaction the products, prices, brand of products, product numbers, merchant, and merchant location are known by the system. Next, the system begins filtering the compiled data into total spend item level affinity data. In this way, initially, the system identifies customer selected products at each of the one or more merchants of the transactions during the time period, as illustrated in block 406, the system identifies patterns or loyalty in products purchased by the customer at the merchant. As illustrated in block 408, the system may also identify patterns in merchants visited by the customer within the total spend time frame.

Next, once patterns are identified for both products purchased at merchants 406 and patterns in merchant shopping by a customer 408, the system continues by using this data to identify loyalty for merchants irrespective of product brands, as illustrated in block 410 and identify loyalty for products irrespective of merchant, as illustrated in block 412. In some embodiments, the system may identify loyalty of customers to merchants, brands, or product category. In this way, in some embodiments, the system identifies merchant patterns based on the item level data. In some embodiments, the system identifies product patterns based on the item level data. In yet other embodiments, the system identifies category patterns based on the item level data. The patterns identify which products the customer is purchasing, during a time frame, at each merchant. In this way, the system using a distributive network through specific network data feeds of the unique distributive network allows for patterning and mapping of item level product purchase data at merchants during a time period. For example, the system may identify that a customer purchases meat and poultry at Merchant X, but all other grocery goods at Merchant Y. In this way, there may be a brand or category loyalty to the meat and poultry goods at Merchant X, while an overall merchant loyalty or affinity for Merchant Y.

As illustrated in block 410, the system identifies loyalty for merchants irrespective of product brands. In this way, the system may recognize merchant loyalty. The merchant loyalty identification may go one step further by identifying specific brands, products, or the like that the customer has purchased at that merchant. If there is no specific brand pattern identified, the system may determine that the customer has a strong merchant loyalty and the brands or products sold by that merchant are not relevant to the customer. In some embodiments, there may be more of a loyalty towards brands or categories of products that are carried by the merchant. In this way, the system may identify that the customer regularly transacts at Merchant X but only usually purchases meats at Merchant X. In this way, the system identifies that the customer has an affinity towards the meats or a product category for Merchant X.

As illustrated in block 412, the system identifies customer loyalty for products irrespective of merchants. In this way, the system identifies customer loyalty for product brands or product categories. As such, the customer may continually purchase the same brand or category of products at multiple merchants. In this way, the system identifies a loyalty to the brand or category.

Finally, as illustrated in block 414, the process 400 ends by compiling the total spend item level affinity data in the form of purchase patterns and loyalty data associated with the customer during the time frame.

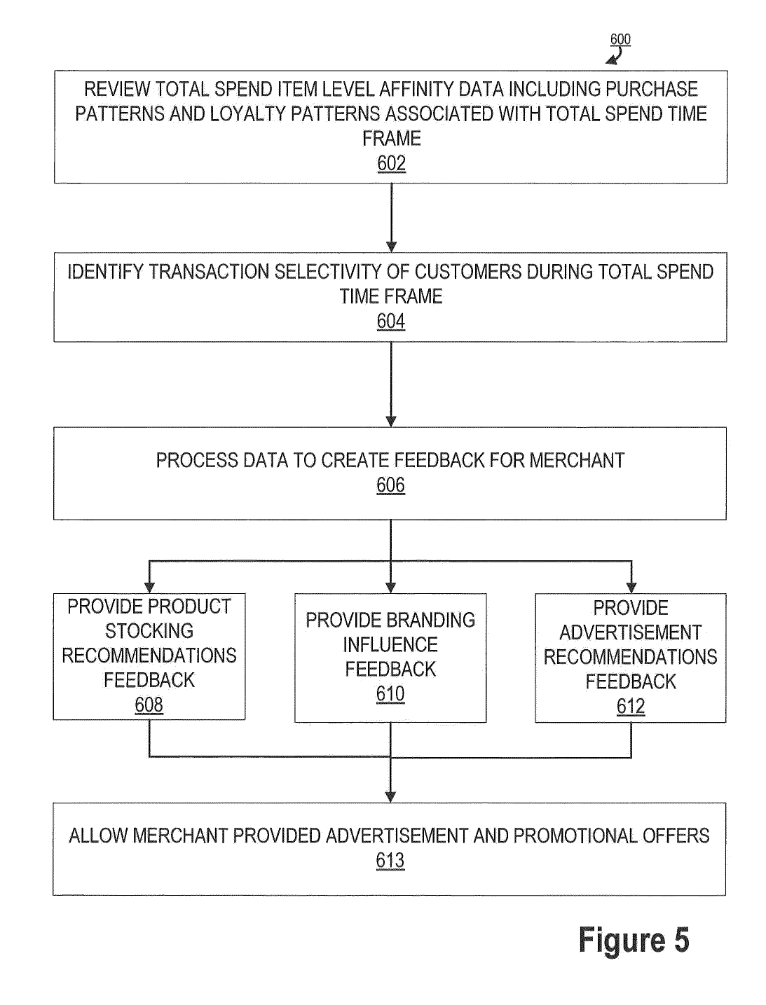

FIG. 5 illustrates a process map for identifying and presenting total spend data to a merchant for branding and stocking effectiveness 600, in accordance with one embodiment of the present invention. As illustrated in block 602, the process 600 is initiated by reviewing the total spend item level affinity data including the purchase patterns and loyalty patterns associated with the time frame. Once reviewed, the system further identifies transaction selectivity of customers during the total spend time frame. As such, identifying the product categories, brands, and the like that the customer purchases in an item level or basket level affinity.

Next, as illustrated in block 606, the process 600 continues by processing the data to create total spend feedback for a merchant. In this way, the system may generalize the item level transaction data across the financial institution. In this way, the system once reviewing the compiled and grouped data based on pattern, loyalty, merchant, customer, product, brand, category, or the like, the data may be generalized within the financial institution. As such, the generalized information includes information about a number of customers that purchased a product, a category of products, or from a merchant within the total spend period. The generalized information does not include information about the customer making a purchase, but instead general numbers associated with the number of customers that purchased a product, a category of products, or from a merchant within a given time period.

In some embodiments, the system may provide feedback data for one or more of merchant stocking recommendations 608, brand or category association influence feedback 610, and/or target advertisement feedback 612. The feedback may be in the form of generalized item level transaction data in the form of graphs, charts, or the like that depict loyalty, affinity, product, product category, or the like. The feedback may be presented via an interface or the like in an interactive format such that the merchant may further search or identify the data required for future feedback the merchant desires.

In some embodiments, system may provide merchant stocking feedback, as illustrated in block 608. In this way, the system may determine products or categories of products that customers go to other merchants to purchase. In this way, the system may provide the requesting merchant feedback as to the products that the merchant carries that aid the merchant in bringing in or continuing to maintain customers and/or providing the merchant with information related to which products should be provided and maintained at the merchant.

In some embodiments, the system may provide brand or category association influence feedback, as illustrated in block 610. In this way, the system may analyze item level data and provide the merchant with an indication as to the effects that brands the merchant currently carries, both positive and negative, based on the item level data and loyalty data identified.

In some embodiments, as illustrated in block 612, the system may provide target advertisement feedback. In this way, the system may provide, based on the item level data, one or more merchants with feedback based on tie patterns and/or loyalty data that provide the merchant with targeted advertisement feedback.

Finally, as illustrated in block 613, the system may allow merchant provided offers and advertisements to be generated through the system to financial intuition product holding customers.

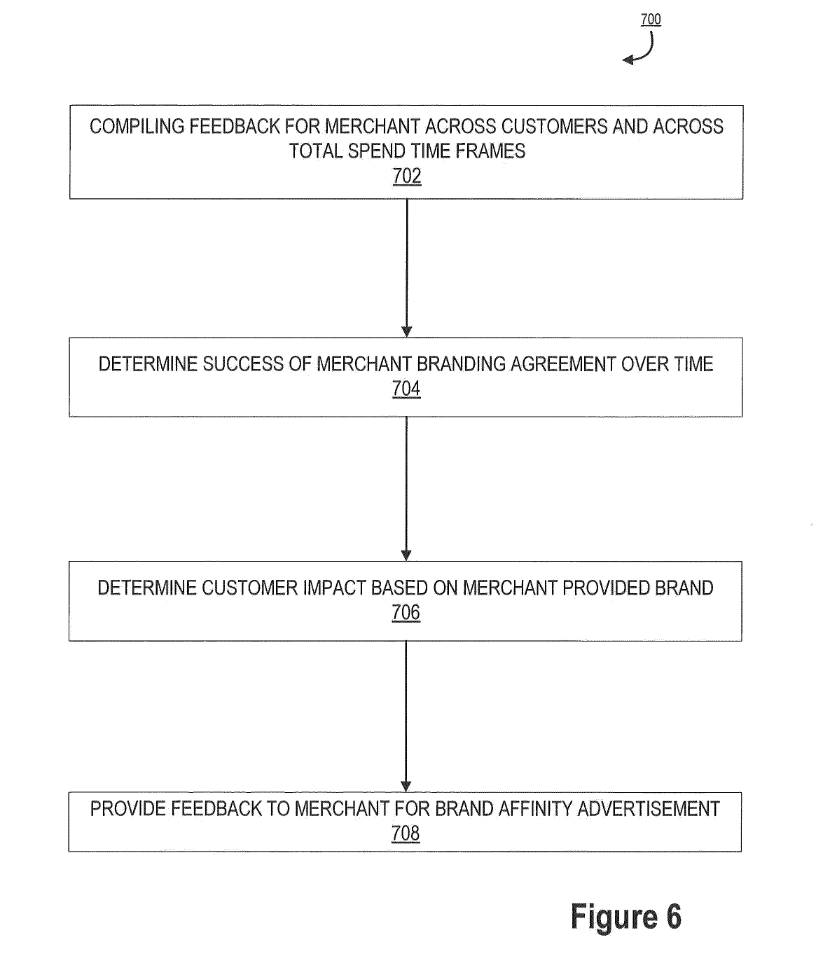

FIG. 6 illustrates a process flow for identifying and presenting total spend data to merchants for advertisement effectiveness 700, in accordance with one embodiment of the present invention. In some embodiments, the system may provide the merchant with exclusive brand feedback based on brands that the merchant exclusively carries and the impact that those relationships have on the merchant. As illustrated in block 702, the process starts by compiling the total spend item level feedback for merchants across various customers and across various total spend time frames. Once this data is collecting, the system may determine the success of exclusive product brands carried by the merchant over a long duration of time, as illustrated in block 704. Then the system determines customer impact based on merchant provided brands, as illustrated in block 706. In this way, the system may identify the customers that transact with that merchant based exclusively on the branding. For example, customers that only purchase the brand product at that merchant and nothing or very little else. In some embodiments, the system may identify the customers that are merchant loyal and purchase that brand product because it is available at the merchant. Furthermore, in some embodiments, the system may identify the customers that do not shop at that merchant because of the branding. These data points are based on the patterns of customer transactions over the total spend time frame.

Finally, as illustrated in block 708, the system may provide the merchant with feedback based on brand affinity for advertisement purposes.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for item level affinity tracking, the system comprising:
a memory device with non-transitory computer-readable program code stored thereon;
a communication device;
a communicable linkage to a distributive network of specific network data feeds;
a processing device operatively coupled to the memory device and the communication device, wherein the processing device is configured to execute the computer-readable program code to:
identify customer transactions occurring within a time range that utilizes a financial institution product;
trigger, through the network data feeds a collection of customer transaction data based on the identification of customer transactions, occurring with the time range;
retrieve, utilizing the distributive network and the specific network data feeds, item level data for products of the transaction, wherein item level data includes specific information identifying a product including a model number, name, and manufacturer of the product of the transaction;
compile the item level data across a financial institution;
identify an affinity of the customer for merchants based on the customer transactions and item level data within the time range;
identify an affinity of the customer for product brands based on the customer transactions and item level data within the time range;
generalize the identified affinity of the customer for merchants and brands for one or more customers; and
provide through the network data feeds feedback data to merchants for one or more of merchant product stocking feedback, brand or category association influence feedback, and/or target advertisement feedback.

2. The system of claim 1, wherein identifying an affinity of the customer for merchants based on the customer transactions and item level data within the time range further comprises identifying patterns in the customer transactions illustrating a loyalty to one or more merchants, wherein the system uses the distributive network through specific network data feeds of the distributive network to pattern and map the merchant where the customer purchased each item associated with the item level data for the customer transactions during the time period.

3. The system of claim 1, wherein identifying an affinity of the customer for product brands based on the customer transactions and item level data within the time range further comprises identifying patterns in the customer transactions illustrating a loyalty to one or more brands of products, irrespective of the merchant of the customer transactions, wherein the system uses the distributive network through specific network data feeds of the distributive network to pattern and map the brands of products purchased during the customer transactions using the item level data for the customer transactions during the time period.

4. The system of claim 1 further comprising providing exclusive brand impact feedback to the merchant, wherein providing exclusive brand impact feedback to the merchant comprises:
identifying exclusive brands of the merchant, wherein the exclusive brands of the merchant are product brands exclusively carried by the merchant;
identifying one or more customers that transact with that merchant based exclusively on the brand based on the compile item level data;
identifying the one or more customers that are merchant loyal and purchase the exclusive brand product because it is available at the merchant based on the compile item level data;
identifying the one or more customers that do not transact at the merchant because of the exclusive brand product based on the compile item level data;
patterning the compile item level data based on the identification of one or more customers that transact with that merchant based exclusively on the brand, the one or more customers that are merchant loyal and purchase the exclusive brand product because it is available at the merchant, and the one or more customers that do not transact at the merchant because of the exclusive brand product based on the compile item level data; and
providing the merchant with feedback based on the patterning.

5. The system of claim 1, wherein generalizing the item level data across the financial institution includes removing customer information from the item level data and correlating each of the products of each of the transactions for the item level data into a category of product, brand of product, and/or by merchant associated with the transaction.

6. The system of claim 1, wherein providing merchant product stocking feedback further comprises:
determining products or categories of products that one or more customers purchase exclusively at the merchants;
determining one or more customers that transact at the merchant but do not purchase the products or categories of products at that merchant but instead purchase those products or categories of products at a second merchant; and
presenting merchant with merchant product stocking feedback comprising an interactive interface for review of the feedback to aid the merchant in bringing in or continuing to maintain customers and/or providing the merchant with information related to which products should be provided and maintained at the merchant.

7. The system of claim 1, wherein providing target advertisement feedback further comprises:
determining products or categories of products that one or more customers purchase exclusively at the merchants;
determining customers that do not transact at the merchant and determine the products or category of products that the customers purchase at a second merchant; and
presenting merchant with target advertisement feedback for the customers that do not transact at the merchant, wherein the target advertisements are for the products or category of products that the customers purchase at a second merchant.

8. A computer program product item level affinity tracking, the computer program product comprising at least one non-transitory computer-readable medium having computer-readable program code portions embodied therein, the computer-readable program code portions comprising:
an executable portion configured for identifying customer transactions occurring within a time range that utilizes a financial institution product;
an executable portion configured for triggering, through a network data feeds a collection of customer transaction data based on the identification of customer transactions, occurring with the time range;
an executable portion configured for retrieving, utilizing the distributive network and the specific network data feeds, item level data for products of the transaction, wherein item level data includes specific information identifying a product including a model number, name, and manufacturer of the product of the transaction;
an executable portion configured for compiling the item level data across a financial institution;
an executable portion configured for identifying an affinity of the customer for merchants based on the customer transactions and item level data within the time range;
an executable portion configured for identifying an affinity of the customer for product brands based on the customer transactions and item level data within the time range;
an executable portion configured for generalizing the identified affinity of the customer for merchants and brands for one or more customers; and
an executable portion configured for providing through the network data feeds feedback data to merchants for one or more of merchant product stocking feedback, brand or category association influence feedback, and/or target advertisement feedback.

9. The computer program product of claim 8, wherein identifying an affinity of the customer for merchants based on the customer transactions and item level data within the time range further comprises identifying patterns in the customer transactions illustrating a loyalty to one or more merchants, wherein the system uses the distributive network through specific network data feeds of the distributive network to pattern and map the merchant where the customer purchased each item associated with the item level data for the customer transactions during the time period.

10. The computer program product of claim 8, wherein identifying an affinity of the customer for product brands based on the customer transactions and item level data within the time range further comprises identifying patterns in the customer transactions illustrating a loyalty to one or more brands of products, irrespective of the merchant of the customer transactions, wherein the system uses the distributive network through specific network data feeds of the distributive network to pattern and map the brands of products purchased during the customer transactions using the item level data for the customer transactions during the time period.

11. The computer program product of claim 8, further comprising providing exclusive brand impact feedback to the merchant, wherein providing exclusive brand impact feedback to the merchant comprises:
identifying exclusive brands of the merchant, wherein the exclusive brands of the merchant are product brands exclusively carried by the merchant;
identifying one or more customers that transact with that merchant based exclusively on the brand based on the compile item level data;
identifying the one or more customers that are merchant loyal and purchase the exclusive brand product because it is available at the merchant based on the compile item level data;
identifying the one or more customers that do not transact at the merchant because of the exclusive brand product based on the compile item level data;
patterning the compile item level data based on the identification of one or more customers that transact with that merchant based exclusively on the brand, the one or more customers that are merchant loyal and purchase the exclusive brand product because it is available at the merchant, and the one or more customers that do not transact at the merchant because of the exclusive brand product based on the compile item level data; and
providing the merchant with feedback based on the patterning.

12. The computer program product of claim 8, wherein generalizing the item level data across the financial institution includes removing customer information from the item level data and correlating each of the products of each of the transactions for the item level data into a category of product, brand of product, and/or by merchant associated with the transaction.

13. The computer program product of claim 8, wherein providing merchant product stocking feedback further comprises:
determining products or categories of products that one or more customers purchase exclusively at the merchants;
determining one or more customers that transact at the merchant but do not purchase the products or categories of products at that merchant but instead purchase those products or categories of products at a second merchant; and
presenting merchant with merchant product stocking feedback comprising an interactive interface for review of the feedback to aid the merchant in bringing in or continuing to maintain customers and/or providing the merchant with information related to which products should be provided and maintained at the merchant.

14. The computer program product of claim 8, wherein providing target advertisement feedback further comprises:
determining products or categories of products that one or more customers purchase exclusively at the merchants;
determining customers that do not transact at the merchant and determine the products or category of products that the customers purchase at a second merchant; and
presenting merchant with target advertisement feedback for the customers that do not transact at the merchant, wherein the target advertisements are for the products or category of products that the customers purchase at a second merchant.

15. A computer-implemented method for item level affinity tracking, the method comprising:
providing a computing system comprising a computer processing device, a non-transitory computer readable medium, and a communicable linkage to a distributive network of specific network data feeds, where the computer readable medium comprises configured computer program instruction code, such that when said instruction code is operated by said computer processing device, said computer processing device performs the following operations:
identifying customer transactions occurring within a time range that utilizes a financial institution product;
triggering, through the network data feeds a collection of customer transaction data based on the identification of customer transactions, occurring with the time range;
retrieving, utilizing the distributive network and the specific network data feeds, item level data for products of the transaction, wherein item level data includes specific information identifying a product including a model number, name, and manufacturer of the product of the transaction;
compiling the item level data across a financial institution;
identifying an affinity of the customer for merchants based on the customer transactions and item level data within the time range;
identifying an affinity of the customer for product brands based on the customer transactions and item level data within the time range;
generalizing the identified affinity of the customer for merchants and brands for one or more customers; and
providing through the network data feeds feedback data to merchants for one or more of merchant product stocking feedback, brand or category association influence feedback, and/or target advertisement feedback.

16. The computer-implemented method of claim 15, wherein identifying an affinity of the customer for merchants based on the customer transactions and item level data within the time range further comprises identifying patterns in the customer transactions illustrating a loyalty to one or more merchants, wherein the system uses the distributive network through specific network data feeds of the distributive network to pattern and map the merchant where the customer purchased each item associated with the item level data for the customer transactions during the time period.

17. The computer-implemented method of claim 15, wherein identifying an affinity of the customer for product brands based on the customer transactions and item level data within the time range further comprises identifying patterns in the customer transactions illustrating a loyalty to one or more brands of products, irrespective of the merchant of the customer transactions, wherein the system uses the distributive network through specific network data feeds of the distributive network to pattern and map the brands of products purchased during the customer transactions using the item level data for the customer transactions during the time period.

18. The computer-implemented method of claim 15 further comprising providing exclusive brand impact feedback to the merchant, wherein providing exclusive brand impact feedback to the merchant comprises:
identifying exclusive brands of the merchant, wherein the exclusive brands of the merchant are product brands exclusively carried by the merchant;
identifying one or more customers that transact with that merchant based exclusively on the brand based on the compile item level data;
identifying the one or more customers that are merchant loyal and purchase the exclusive brand product because it is available at the merchant based on the compile item level data;
identifying the one or more customers that do not transact at the merchant because of the exclusive brand product based on the compile item level data;
patterning the compile item level data based on the identification of one or more customers that transact with that merchant based exclusively on the brand, the one or more customers that are merchant loyal and purchase the exclusive brand product because it is available at the merchant, and the one or more customers that do not transact at the merchant because of the exclusive brand product based on the compile item level data; and
providing the merchant with feedback based on the patterning.

19. The computer-implemented method of claim 15, wherein generalizing the item level data across the financial institution includes removing customer information from the item level data and correlating each of the products of each of the transactions for the item level data into a category of product, brand of product, and/or by merchant associated with the transaction.

20. The computer-implemented method of claim 15, wherein providing merchant product stocking feedback further comprises:
determining products or categories of products that one or more customers purchase exclusively at the merchants;
determining one or more customers that transact at the merchant but do not purchase the products or categories of products at that merchant but instead purchase those products or categories of products at a second merchant; and
presenting merchant with merchant product stocking feedback comprising an interactive interface for review of the feedback to aid the merchant in bringing in or continuing to maintain customers and/or providing the merchant with information related to which products should be provided and maintained at the merchant.

21. The computer-implemented method of claim 15, wherein providing target advertisement feedback further comprises:
determining products or categories of products that one or more customers purchase exclusively at the merchants;
determining customers that do not transact at the merchant and determine the products or category of products that the customers purchase at a second merchant; and
presenting merchant with target advertisement feedback for the customers that do not transact at the merchant, wherein the target advertisements are for the products or category of products that the customers purchase at a second merchant.
